(19) United States
(12) Patent Application Publication
(10) Pub. No.: US 2013/0345042 A1
(43) Pub. Date: Dec. 26, 2013

(54) LEAD-FREE GLASS FOR SEMICONDUCTOR ENCAPSULATION AND ENCAPSULATOR FOR SEMICONDUCTOR ENCAPSULATION

(71) Applicants: Koichi Hashimoto, Shiga (JP); Kumiko Kondo, Shiga (JP)

(72) Inventors: Koichi Hashimoto, Shiga (JP); Kumiko Kondo, Shiga (JP)

(73) Assignee: NIPPON ELECTRIC GLASS CO., LTD., Otsu-shi, Shiga (JP)

(21) Appl. No.: 13/882,893

(22) PCT Filed: Oct. 31, 2011
(86) PCT No.: PCT/JP2011/075092

§ 371 Date: May 1, 2013

(30) Foreign Application Priority Data
Nov. 4, 2010 (JP) 2010-247306

(51) Int. Cl. C03C 3/093; C03C 3/066

(52) U.S. Cl. CPC C03C 3/093; C03C 3/066
USPC 501/67; 501/79

(57) ABSTRACT

The present invention provides a lead-free glass for semiconductor encapsulation, which can encapsulate semiconductor devices at a low temperature, has an excellent acid durability and hardly precipitates crystals when forming a glass tube, and an encapsulator for semiconductor encapsulation made of the glass. The glass comprises, as a glass composition, from 45 to 58% of SiO₂, from 0 to 6% of Al₂O₃, from 14.5 to 30% of B₂O₃, from 0 to 3% of MgO, from 0 to 3% of CaO, from 4.2 to 14.2% of ZnO, from 5 to 12% of Li₂O, from 0 to 15% of Na₂O, from 0 to 7% of K₂O, from 15 to 30% of Li₂O+Na₂O+K₂O, and from 0.1 to 8% of TiO₂, in terms of % by mol, wherein a ratio of ZnO to Li₂O is in the range from 0.84 to 2.

### TECHNICAL FIELD

The present invention relates to a lead-free glass for semiconductor encapsulation and particularly to a lead-free glass used for encapsulating semiconductor devices such as silicone diodes, light-emitting diodes, thermistors, and the like.

### BACKGROUND ART

Semiconductor devices, such as thermistors, diodes and LEDs, require an air-tight encapsulation. In the past, an encapsulator made of a lead glass has been used for air-tightly encapsulating semiconductor devices, but recently, an encapsulator made of a lead-free glass, which is introduced in Patent Document 1 or 2, has also been proposed. For such a glass used for a semiconductor encapsulation, a glass raw material is melt in a melting furnace to form the molten glass into a tube shape, and then, the obtained glass tube is cut to a length of about 2 mm and washed, then shipped as a short glass encapsulator which is referred to as a bead. Assembling a semiconductor encapsulation part is carried out by inserting a semiconductor device and a metal wire such as a Dumet wire into an encapsulator and heating. By heating, the glass at the end piece of the encapsulator is softened to fuse and encapsulate the metal wire, thereby the semiconductor device can be air-tightly encapsulated inside the tube. The semiconductor encapsulation part thus produced is subjected to an acid treatment, a plating process, or the like for the sake of eliminating an oxidized layer of the metal wire exposed outside the tube.

For the glass for semiconductor encapsulation which constitutes an encapsulator for semiconductor encapsulation, the following characteristics are required: (1) to be able to encapsulate semiconductor devices at a low temperature which does not deteriorate them, (2) to have a thermal expansion coefficient conformable to the thermal expansion coefficients of metal wires, (3) to have a sufficiently high adhesion between the glass and metal wires, (4) to have a high volume resistivity, (5) to have a sufficiently high chemical durability, particularly, high acid durability to prevent deterioration caused by the acid treatment or the plating process, (6) to hardly precipitate crystals at the forming viscosity to achieve a high productivity (i.e., to have a high devitrification resistance), and the like.

### CITATION LIST

### Patent Document

Patent Document 1: JP-A 2002-37641

Patent Document 2: U.S. Pat. No. 7,102,242

### SUMMARY OF THE INVENTION

### Problems to be Solved by the Invention

When the temperature is high in the process of encapsulating a semiconductor device, the device deteriorates, or a connection of the metal wire deteriorates by exceeding the yield point of the metal to lose the elasticity. To improve this problem, it is preferable to lower the encapsulation temperature of the glass, but a change of the composition simply by reducing the structural component of glass such as SiO₂ or increasing the alkali metal component leads to a deterioration in the acid durability of the glass. When a glass having poor acid durability is subjected to an acid treatment or a plating process, the surface of the glass deteriorates to cause small cracks. If such cracks are present on the surface of the glass, many kinds of contaminations and water easily adhere and the surface resistance of the device is lowered to cause problems with electrical products. Further, if the content of alkali metals in the glass is increased, the thermal expansion coefficient is not conformable to that of the metal wire. Moreover, crystals precipitate to cause a problem such that dimensional stability when forming a glass tube is deteriorated, resulting in a low productivity.

### Means for Solving the Problems

The object of the present invention is to provide a lead-free glass for semiconductor encapsulation, which can encapsulate semiconductor devices at a low temperature, has an excellent acid durability and hardly precipitates crystals when forming a glass tube, and an encapsulator for semiconductor encapsulation.

The present inventors have found out that it is possible to combine achieving the low-temperature encapsulation and preventing a deterioration of the acid durability by maintaining the content of SiO₂ or TiO₂ and further increasing the ZnO content, and that a stable glass can be obtained by controlling the content of Li₂O to 12% or less and further controlling the ratio of ZnO to Li₂O in the range from 0.84 to 2 since if the ZnO content is increased, the zinc silicate (Li₂ZnSiO₄ crystals) easily occurs.

That is, the lead-free glass for semiconductor encapsulation of the present invention comprises, as a glass composition, from 45 to 58% of SiO₂, from 0 to 6% of Al₂O₃, from 14.5 to 30% of B₂O₃, from 0 to 3% of MgO, from 0 to 3% of CaO, from 4.2 to 14.2% of ZnO, from 5 to 12% of Li₂O, from 0 to 15% of Na₂O, from 0 to 7% of K₂O, from 15 to 30% of Li₂O+Na₂O+K₂O, and from 0.1 to 8% of TiO₂, in terms of % by mol, wherein a ratio of ZnO to Li₂O is in the range from 0.84 to 2. Meanwhile, the term “lead-free” used herein indicates that a lead material is not actively added as a glass raw material, and it does not indicate the incorporation from impurity or likes is completely excluded. More particularly, it means that the content of PbO in the glass composition is 1000 ppm or less, including incorporation from impurity or likes.

In the present invention, SiO₂+TiO₂ is preferably in the range from 52.1 to 56.5%.

According to the above-mentioned constitution, a glass with an excellent acid durability can be obtained.

In the present invention, the temperature corresponding to the viscosity of 10⁶ dPa·s is preferably 650° C. or lower. In the present invention, “temperature corresponding to the viscosity of 10⁶ dPa·s” and “temperature corresponding to the viscosity of 10² dPa·s” mean the temperature determined as follows. First, the softening point is measured by the fiber method in accordance with ASTM C338. Subsequently, the temperature corresponding to viscosity of working point area is determined by the platinum ball pulling-up method. Finally, these viscosity and temperature are applied to Fulcher equation to calculate the temperature corresponding to the viscosity of 10⁶ dPa·s.

The encapsulator for semiconductor encapsulation of the present invention is made of the glass described above.

### Effect of the Invention

The lead-free glass for semiconductor encapsulation of the present invention can encapsulate semiconductor devices at low temperature. Further, with excellence in acid durability, cracks do not occur on the surface even if the glass is subjected to an acid treatment or a plating process after encapsulating devices, thus semiconductor encapsulation parts with high reliability can be produced. Furthermore, crystals hardly precipitate when forming a glass tube and therefore, encapsulators can be stably produced in large quantities.

### Embodiments for Carrying out the Invention

In the glass for semiconductor encapsulation of the present invention, the reason for defining the glass composition range as described above will be explained as follows. Meanwhile, the following expression of “%” indicates “% by mole”, unless otherwise specified.

SiO₂ is a main component, and is an important component for stabilization of the glass. Further, it has a great effect of enhancing the acid durability. Meanwhile, SiO₂ is also a component which increases an encapsulation temperature. The content of SiO₂ is from 45 to 58%, preferably from 48.5 to 55%, and more preferably from 49 to 53.6%. If the content of SiO₂ is excessively small, it is difficult to exhibit the above-mentioned effects. In contrast, if the content of SiO₂ is excessively large, the low-temperature encapsulation becomes difficult.

Al₂O₃ is a component which inhibits precipitation of Si-containing crystals and enhances the water durability and the acid durability. Al₂O₃ is also a component which increases the viscosity of the glass. The content of Al₂O₃ is from 0 to 6%, preferably from 0.1 to 3%, and more preferably from 0.4 to 1.1%. If the content of Al₂O₃ is excessively small, the above-mentioned effects cannot be obtained. In contrast, if the content of Al₂O₃ is excessively large, the viscosity of the glass becomes excessively high, the formability is easily lowered, and the low-temperature encapsulation becomes difficult. Further, Li-containing crystals easily precipitate because of lacking the balance of the composition.

B₂O₃ is a component which stabilizes the glass, and simultaneously, is a component which lowers the viscosity of the glass. Meanwhile, B₂O₃ is also a component which lowers the chemical durability. The content of B₂O₃ is from 14.5 to 30%, preferably from 15 to 25%, and more preferably from 15.5 to 18.2%. If the content of B₂O₃ is excessively small, it is difficult to exhibit the above-mentioned effects. In contrast, if the content of B₂O₃ is excessively large, the chemical durability is deteriorated.

The alkaline earth metal oxides RO, (MgO, CaO, SrO and BaO), have an excellent effect of stabilizing the glass. Meanwhile, for the glass of which the temperature corresponding to a viscosity of 10⁶ dPa·s is 650° C. or lower, the effect of lowering the temperature of the glass by RO may not be expected, and rather there is a concern that the encapsulation temperature may be raised. Accordingly, it is preferable that the content of RO is low, and the total content is 7% or less, 3% or less, particularly 1.8% or less, furthermore 0.8% or less. Further, each alkaline earth metal oxide component will be explained below.

Each content of MgO or CaO is from 0 to 3%, preferably from 0 to 1%, more preferably from 0 to 0.5%.

It is preferable that the content of SrO is from 0 to 7%, from 0 to 5%, from 0 to 3%, from 0 to 2%, particularly from 0 to 1%.

It is preferable basically not to comprise BaO which has an adverse effect on the acid durability. It is preferable that the content of BaO is, in terms of % by weight, from 0 to <1% (i.e., less than 1%), particularly from 0 to 0.7%.

ZnO is a component which can lower the viscosity of the glass without raising expansion relative to the alkali metal oxides or deteriorating the acid durability. The content of ZnO is from 4.2 to 14.2%, preferably from 7.4 to 14.2%, more preferably from 7.4 to 9.9%, particularly preferably from 8 to 9.9%. If the content of ZnO is excessively small, it is difficult to exhibit the above-mentioned effects. In contrast, if it is excessively large, crystals easily precipitate.

The alkali metal oxides R₂O (Li₂O, Na₂O and K₂O) have an effect of lowering the viscosity of the glass, or raising the expansion. Particularly, Li₂O is used as an essential component in the glass of the above-mentioned composition because its effect of lowering the viscosity of the glass is excellent. Meanwhile, if the R₂O is used in excess, the expansion is raised excessively, and thus, a crack is generated in the gap with the metal wire such as Dumet wire. Therefore, it is preferable that the total content of R₂O is from 15 to 30%, preferably from 17 to 27%, particularly from 19 to 25%. Incidentally, each alkali metal oxide component will be explained below.

As described above, Li₂O has a great effect of reducing the viscosity of glass, but if the content is large, Li-containing crystals easily occur. Therefore, the content of Li₂O is from 5 to 12%, preferably from 5 to 11%, from 5 to 10%, from 5 to <9% (less than 9%), from 6 to 8.7%, more preferably from 7 to 8.7%. If the content of Li₂O is excessively small, it is difficult to exhibit the above-mentioned effects. In contrast, if the content of Li₂O is excessively large, devitrification easily occurs and Li₂ZnSiO₄ crystals easily precipitate. Further, the acid durability tends to be deteriorated.

Further, even when the content of Li₂O is controlled to 12% or less, if the content of ZnO is excessively large with respect to the content of Li₂O, devitrification easily occurs. Thus, in the present invention, the ratio of these components is controlled to from 0.84 to 2, preferably from 0.85 to 1.5, more preferably from 0.9 to 1.5, particularly preferably from 1 to 1.2, in terms of ZnO to Li₂O (ZnO/Li₂O). If the value of ZnO to Li₂O is small, the content of ZnO becomes small and the low-temperature encapsulation becomes impossible. In contrast, if the value of ZnO to Li₂O is excessively large, Li₂ZnSiO₄ crystals easily precipitate.

Na₂O has an effect of stabilizing a glass to prevent the glass from devitrifying, in addition to the above-mentioned effects in common with the alkali metal oxides. On the other hand, Na₂O deteriorates the acid durability of the glass. In the present invention, it is preferable to introduce Na₂O in view of stabilization of the glass. The content of Na₂O is from 0 to 15%; preferably from 2 to 12%, from 5 to 12%, from 6 to 12%; more preferably from 5 to 11%. If the content of Na₂O is excessively small, it is difficult to exhibit the above-mentioned effects. In contrast, if the content of Na₂O is excessively large, devitrification easily occurs.

K₂O has an effect of stabilizing a glass to prevent the glass from devitrifying, in addition to the above-mentioned effects in common with the alkali metal oxides. On the other hand, K₂O deteriorates the acid durability of the glass. The content of K₂O is from 0 to 7%, preferably from 0.1 to 3%, more preferably from 0.1 to 2.3%, particularly preferably from 0.6 to 2.3%. If the content of K₂O is excessively large, devitrification easily occurs.

Incidentally, in order to stabilize the glass, either one of Na₂O or K₂O or both of them are preferably comprised.

TiO₂ is a component added to enhance acid durability. On the other hand, TiO₂ is characterized that it tends to cause precipitation of crystals and deteriorate the devitrification resistance of the glass. Thus, if TiO₂ is comprised excessively, the glass is easily devitrified by the contact with metals or refractory materials, and there may be a case to cause a problem that the dimensional accuracy of the obtained glass is deteriorated by the devitification substances. The content of TiO₂ is from 0.1 to 8%, preferably from 0.3 to 5%, more preferably from 1.1 to 4%.

Further, in the glass of the present invention, it becomes easier to combine the acid durability and the devitrification tendency (productivity) by strictly controlling the total content of SiO₂ and TiO₂. It is possible to enhance the acid durability efficiently by increasing the total content of SiO₂ and TiO₂. It is preferable that the total content of SiO₂ and TiO₂ is from 52.1 to 56.5%, particularly from 52.1 to 55%. It is preferable that the total content of SiO₂ and TiO₂ is 52.1% or more in view of more enhancing the acid durability. If the total content of SiO₂ and TiO₂ is 56.5% or less, the glass is hardly hardened and the low-temperature encapsulation becomes easier. Further, the liquidus temperature hardly becomes high and devitrification hardly occurs when forming. As a result, the dimensional accuracy of the tube and the productivity are enhanced.

To the lead-free glass for semiconductor encapsulation of the present invention, various components may be added other than the above components within a range in which the characteristics of the glass are not damaged. For example, F may be added up to 0.5% in order to lower the viscosity of the glass, and CeO₂ may be added up to 5% as a refining agent. Further, 5% or less of each of Bi₂O₃, La₂O₃, or ZrO₂ may be comprised in order to enhance the chemical durability. However, environmentally undesirable components such as As₂O₃ or Sb₂O₃ should not be added. Specifically, the content of As₂O₃ or Sb₂O₃ is controlled to 0.1% or less.

For the lead-free glass for semiconductor encapsulation of the present invention having the composition above, the temperature corresponding to the viscosity of 10⁶ dPa·s is 650° C. or lower, preferably from 620 to 635° C., more preferably from 620 to 630° C., particularly preferably from 620 to 628° C. The temperature corresponding to the viscosity of 10⁶ dPa·s approximately corresponds to the encapsulation temperature for semiconductor devices. Therefore, the glass of the present invention can encapsulate semiconductor devices at a temperature of 650° C. or lower. In order to control the temperature at which the viscosity of the glass is 10⁶ dPa·s to 650° C. or lower, it is preferable that a lot of Li₂O among the alkali components are comprised and that SiO₂—B₂O₃—R₂O based glass comprising B₂O₃ as an essential component are prepared.

In addition, for the lead-free glass for semiconductor encapsulation of the present invention, it is preferable that the temperature corresponding to the viscosity of 10² dPa·s is 1,000° C. or lower, particularly from 950 to 965° C. The temperature corresponding to the viscosity of 10² dPa·s is the melting temperature of the glass. Therefore, the glass of the present invention can be melted at a low temperature with low energy consumption. Incidentally, the temperature corresponding to the viscosity of 10² dPa·s can be controlled to 1,000° C. or lower by increasing the content of the alkali metal oxides or ZnO. Particularly, in order to control the temperature corresponding to the viscosity of 10² dPa·s to 965° C. or lower, the content of ZnO is preferably 7.4% or more.

For the lead-free glass for semiconductor encapsulation of the present invention, in order to seal with Dumet, it is preferable that the thermal expansion coefficient of the glass at the temperature range from 30° C. to 380° C. is from 85 to 105×10⁻⁷/° C., preferably from 85 to 100×10⁻⁷/° C., more preferably from 90 to 100×10⁻⁷/° C., even more preferably from 91 to 98×10⁻⁷/° C., particularly preferably from 92 to 96×10⁻⁷/° C.

Further, for the lead-free glass for semiconductor encapsulation of the present invention, the volume resistance is preferably as high as possible. Particularly, the volume resistance value at 150° C. is preferably 7 or higher, particularly preferably 9 or higher, and even more preferably 10 or higher in terms of Log ρ(Ω·cm). Incidentally, when the volume resistance of the glass is low, an electrical current slightly flows, for example, between electrodes of a diode to form a circuit as if a resistor is installed in parallel to the diode.

Furthermore, for the lead-free glass for semiconductor encapsulation of the present invention, the weight loss per unit area (μg/cm²) after immersed in a solution comprising 5% by weight of sulfuric acid (30° C.-36N) for 60 seconds is preferably 1,000 μg/cm² or less, 500 μg/cm² or less, 300 μg/cm² or less, 200 μg/cm² or less, 150 μg/cm² or less, 120 μg/cm² or less, 100 μg/cm² or less, and 80 μg/cm² or less. The weight loss per unit area as controlled to the above-defined value or less is preferable in view of preventing cracks or the like occurring on the surface of the glass in the plating process.

Subsequently, a method for producing an encapsulator for semiconductor encapsulation which is made of the lead-free glass for semiconductor encapsulation of the present invention, will be described below.

A method for producing an encapsulator for semiconductor encapsulation on an industrial scale comprises a compounding and mixing step of measuring and mixing minerals or purified crystal powder comprising components constituting a glass to compound a raw material to be introduced into a furnace, a melting step of melting and vitrifying the raw material, a forming step of forming the molten glass into a shape of a tube, and a processing step of cutting the tube into a predetermined size.

Firstly, glass raw materials are compounded and mixed. The raw materials consist of minerals made of a plurality of components such as oxides and carbonates and impurities, and may be compounded in consideration of analytical values, and thus, the raw materials are not limited. These are measured by weight, and mixed by a proper mixer depending on the scale, such as a V-shaped mixer, a rocking mixer and a mixer with agitating blades, to obtain a raw material to be introduced.

Subsequently, the raw material is introduced into a glass melting furnace to vitrify. The common melting furnace comprises a melting bath for melting and vitrifying the raw materials, a refining bath for raising bubbles in the glass to remove them, and a passage (feeder) for lowering the viscosity of the glass thus refined to a value suitable for forming, and then guiding the glass into a forming apparatus. As the melting furnace, a furnace made of a refractory material, or a furnace lined with platinum on the inside thereof is used, and is heated by heating with a burner or by applying an electric current to the glass. The introduced raw material is normally vitrified in the melting bath at a temperature of from 1,100 to 1,600° C., and then introduced into the refining bath at a temperature of from 1,100 to 1,400° C. Herein, bubbles in the glass are floated and removed. After the glass comes out from the refining bath, the temperature drops while passing through the feeder to the forming apparatus, thereby obtaining a viscosity of from 10⁴ to 10⁶ dPa·s, which is suitable for glass formation.

Subsequently, the glass is formed into a tube shape by the forming apparatus. As a method for forming, Danner process, Vello process, downdraw process or updraw process may be used.

Thereafter, by cutting the glass tube into a predetermined size, an encapsulator for semiconductor encapsulation can be obtained. The cutting process of the glass tube can be performed by cutting the tubes for every one line by a diamond cutter, but as a method suitable for mass production, a method, which includes tying a plurality of glass tubes into one line and then cutting the line by a diamond wheel cutter such that a plurality of glass tubes is cut at once, is normally used.

Subsequently, a method for encapsulating semiconductor devices using an encapsulator which is made of the glass of the present invention, will be described below.

Firstly, metal wires such as Dumet wires are set using a jig such that a semiconductor device is clamped between the materials at both sides in the encapsulator. Thereafter, the entire structure is heated to a temperature of 650° C. or lower to soften and deform the encapsulator, thereby performing air-tight encapsulation of the semiconductor device.

However, the air-tight encapsulation body of the semiconductor device as produced by the method above has an oxide layer formed on the surface of the endpiece of the metal wire exposed outside by the effect of the heat treatment, in which state it is impossible to perform solder coating, Sn plating, Ni plating, or the like. Therefore, the air-tight encapsulation body is subjected to an acid treatment to peel off the oxide layer formed on the surface of the endpiece of the metal wire. The acid treatment method employed herein involves treating with an organic sulfonic acid at 50° C. for 5 to 10 minutes; treating with a mixture comprising 0.1% by weight of hydrogen peroxide (15%) added to 80% by weight of 36N sulfuric acid at 80° C. for 20 seconds; or treating with a 36N sulfuric acid (5%) at 20 to 80° C. for 1 minute.

Subsequently, the air-tight encapsulation body, wherein the oxide layer of the metal wire is removed, is washed with tap water and then, subjected to a process such as Sn or Ni sulfate plating or solder dip to coat the endpiece of the metal wire, which enables the production of miniaturized electronic parts, such as silicone diodes, light-emitting diodes and thermistors.

Incidentally, the glass for semiconductor encapsulation of the present invention may be used as a glass tube. In addition, for example, the glass may encapsulate the semiconductor device by making the glass into a powder form and process it to a paste, followed by winding on the semiconductor device and firing.

### EXAMPLES

Hereinafter, the present invention will be described with reference to examples. Incidentally the present invention is not construed as being limited to the following examples.

Tables 1 to 3 show the examples of the present invention (Sample Nos. 1 to 3 and Nos. 6 to 14) and the comparative examples (Sample Nos. 4 and 5). The comparative examples correspond to the examples A and B as described in U.S. Pat. No. 7,102,242.

TABLE 1

| | 1 | 2 | 3 | 4 | 5 |
|---|---|---|---|---|---|
| SiO₂ | 49.9 | 49.1 | 50.3 | 48.8 | 50.1 |
| Al₂O₃ | 0.6 | 0.7 | 0.9 | 1.2 | 1.3 |
| B₂O₃ | 17.6 | 18.2 | 17.6 | 18.3 | 19.4 |
| CaO | 0.0 | 0.0 | 0.0 | 1.1 | 1.2 |
| BaO | 0.0 | 0.0 | 0.0 | 0.8 | 0.9 |
| ZnO | 9.3 | 9.3 | 9.2 | 7.0 | 7.3 |
| Li₂O | 8.4 | 8.5 | 8.4 | 8.5 | 8.8 |
| Na₂O | 9.6 | 8.2 | 10.1 | 8.2 | 8.3 |
| K₂O | 1.3 | 2.7 | 1.0 | 2.7 | 2.8 |
| TiO₂ | 3.1 | 3.2 | 2.4 | 3.2 | 0.0 |
| CeO₂ | 0.1 | 0.1 | 0.1 | 0.0 | 0.0 |
| ZnO/Li₂O | 1.10 | 1.10 | 1.10 | 0.83 | 0.83 |
| SiO₂ + TiO₂ | 53.0 | 52.2 | 52.7 | 52.0 | 50.1 |
| R₂O | 19.4 | 19.4 | 19.5 | 19.5 | 19.9 |
| Thermal expansion | 91.5 | 92.2 | 91.8 | 93.8 | Not |
| coefficient | | | | | measured |
| (×10⁻⁷/° C.) | | | | | |
| Temperature | 633 | 627 | 634 | 636 | Not |
| corresponding | | | | | measured |
| to 10⁶ dPa · s (° C.) | | | | | |
| Temperature | 964 | 963 | 962 | 968 | Not |
| corresponding | | | | | measured |
| to 10² dPa · s (° C.) | | | | | |
| Acid durability | 69 | 98 | 92 | 150 | Not |
| (μg/cm²) | | | | | measured |
| Volume | 11.2 | 11.1 | 10.7 | Not | Not |
| resistance (Ω) | | | | measured | measured |
| Crystal precipi- | | | | | |
| tation Viscosity | | | | | |
| Logη (dPa · S) | | | | | |
| Inside of glass | 5.2 | 4.6 | 6 | 4.5 | Not |
| | | | | | measured |
| Interfacial | 5.3 | 4.7 | 5.9 | 3.8 | Not |
| | | | | | measured |

TABLE 2

| | 6 | 7 | 8 | 9 | 10 |
|---|---|---|---|---|---|
| SiO₂ | 51.0 | 50.0 | 49.0 | 49.0 | 50.0 |
| Al₂O₃ | 0.3 | 0.3 | 0.3 | 0.3 | 0.3 |
| B₂O₃ | 17.8 | 17.8 | 17.8 | 17.8 | 16.8 |
| CaO | 0.0 | 0.0 | 0.0 | 0.0 | 0.0 |
| BaO | 0.0 | 0.0 | 0.0 | 0.0 | 0.0 |
| ZnO | 8.4 | 8.4 | 8.4 | 8.4 | 8.4 |
| Li₂O | 9.4 | 9.4 | 9.4 | 8.6 | 9.4 |
| Na₂O | 10.8 | 10.8 | 10.8 | 11.6 | 10.8 |
| K₂O | 0.2 | 0.2 | 0.2 | 0.2 | 0.2 |
| TiO₂ | 2.0 | 3.0 | 4.0 | 4.0 | 4.0 |
| CeO₂ | 0.1 | 0.1 | 0.1 | 0.1 | 0.1 |
| ZnO/Li₂O | 0.89 | 0.89 | 0.89 | 0.98 | 0.89 |
| SiO₂ + TiO₂ | 53.0 | 53.0 | 53.0 | 53.0 | 54.0 |
| R₂O | 20.4 | 20.4 | 20.4 | 20.4 | 20.4 |
| Thermal expansion | 92.4 | 92.4 | 92.8 | 93.8 | 93.1 |
| coefficient | | | | | |
| (×10⁻⁷/° C.) | | | | | |
| Temperature | 635 | 632 | 630 | 632 | 632 |
| corresponding | | | | | |
| to 10⁶ dPa · s (° C.) | | | | | |
| Temperature | 955 | 944 | 930 | 932 | 940 |
| corresponding | | | | | |
| to 10² dPa · s (° C.) | | | | | |
| Acid durability | 92 | 72 | 94 | 79 | 43 |
| (μg/cm²) | | | | | |
| Volume | Not | Not | Not | Not | Not |
| resistance (Ω) | mea- | mea- | mea- | mea- | mea- |
| | sured | sured | sured | sured | sured |
| Crystal precipi- | | | | | |
| tation Viscosity | | | | | |
| Logη (dPa · S) | | | | | |
| Inside of glass | 4.6 | 4.2 | 3.2 | Not | 3.1 |
| | | | | mea- | |
| | | | | sured | |
| Interfacial | 4.2 | 4.3 | 3.2 | Not | 4.3 |
| | | | | mea- | |
| | | | | sured | |

TABLE 3

| | 11 | 12 | 13 | 14 |
|---|---|---|---|---|
| SiO₂ | 49.0 | 49.2 | 50.5 | 50.3 |
| Al₂O₃ | 0.8 | 0.9 | 0.6 | 0.6 |
| B₂O₃ | 17.8 | 16.9 | 16.9 | 18.3 |
| CaO | 0.0 | 0.0 | 0.0 | 0.0 |
| BaO | 0.0 | 0.0 | 1.7 | 0.0 |
| ZnO | 7.9 | 8.4 | 7.8 | 7.2 |
| Li₂O | 9.4 | 9.4 | 8.5 | 8.3 |
| Na₂O | 10.8 | 10.8 | 10.8 | 12.0 |
| K₂O | 0.2 | 0.2 | 0.0 | 0.0 |
| TiO₂ | 4.0 | 4.1 | 3.2 | 3.1 |
| CeO₂ | 0.1 | 0.1 | 0.1 | 0.1 |
| ZnO/Li₂O | 0.84 | 0.90 | 0.92 | 0.87 |
| SiO₂ + TiO₂ | 53.0 | 53.3 | 53.6 | 53.4 |
| R₂O | 20.4 | 20.4 | 19.3 | 20.3 |
| Thermal expansion | 92.5 | 93.1 | 91.8 | 92.7 |
| coefficient | | | | |
| (×10⁻⁷/° C.) | | | | |
| Temperature | 632 | 630 | 642 | 639 |
| corresponding | | | | |
| to 10⁶ dPa · s (° C.) | | | | |
| Temperature | 944 | 941 | 955 | 951 |
| corresponding | | | | |
| to 10² dPa · s (° C.) | | | | |
| Acid durability | 61 | 58 | 42 | 74 |
| (μg/cm²) | | | | |
| Volume | Not | Not | Not | Not |
| resistance (Ω) | measured | measured | measured | measured |
| Crystal precipi- | | | | |
| tation Viscosity | | | | |
| Logη (dPa · S) | | | | |
| Inside of glass | Not | 3.1 | 5.0 | Not |
| | measured | | | measured |
| Interfacial | Not | 3.6 | 4.9 | Not |
| | measured | | | measured |

Each sample was prepared as follows. Firstly, the glass raw material was compounded so as to be the glass composition as described in the table, and melted using a platinum pot at 1,200° C. for 3 hours. Incidentally, as for the glass raw material, silica powder, aluminum oxide, boric acid, calcium carbonate, barium carbonate, zinc oxide, lithium carbonate, sodium nitrate, potassium carbonate, titanium oxide, cerium oxide and the like were used.

The sample thus obtained was then evaluated in regard to the thermal expansion coefficient, the temperature corresponding to 10⁶ dPa·s, the acid durability (weight loss), volume resistance, and the crystal precipitation viscosity (inside of glass and interface).

As can be seen from Tables 1 to 3, the sample Nos. 1 to 3 and Nos. 6 to 14 as the examples of the present invention enabled an encapsulation at a temperature of 650° C. or lower and had a good acid durability. Further, the crystal precipitation viscosity was high and it was confirmed that devitrification hardly occurs.

The thermal expansion coefficient is a value which measured an average linear thermal expansion coefficient in a temperature range from 30 to 380° C. by an automatic recording differential dilatometer, using a cylindrical measurement sample having a diameter of about 3 mm and a length of about 50 mm.

The encapsulation temperature was determined as follows. First, the softening point was measured by the fiber method in accordance with ASTM C338. Subsequently, the temperature corresponding to the viscosity of working point area was determined by the platinum ball pulling-up method. Finally, the viscosity and the temperature were applied to Fulcher equation to calculate the temperature corresponding to 10⁶ dPa·s as the encapsulation temperature. The temperature corresponding to 10² dPa·s was determined in the same manner as described above.

To determine the acid durability (weight loss), a glass plate (30×30×5 mm) was prepared and performed a mirror surface polishing. After washed, the glass plate was dried at 120° C. for 2 hours or longer, weighed, and dipped in a solution comprising 5% by weight of sulfuric acid (30° C., 36N) for 60 seconds. Subsequently, the glass plate was washed for 60 seconds, dried at 120° C. for 2 hours or longer, and weighed to determine the weight loss, which was given as a weight loss per unit surface area (μg/cm²).

The volume resistivity at 150° C. is a value measured by the method in accordance with ASTM C-657.

To measure the crystal precipitation viscosity, the sample was pulverized, shaken in sieves to have a particle size uniform, and put in a platinum vessel. The vessel was kept in a furnace having a temperature gradient for 24 hours, and its bottom surface was examined to observe precipitation of crystals and determine the interfacial crystal precipitation temperature. Further, the crystal precipitation temperature of the inside of the glass was determined by observing crystals formed at 2 mm apart from the bottom surface. The lowest temperature was chosen respectively, and then, these temperatures were converted to viscosities, which are defined as crystal precipitation viscosities.

### INDUSTRIAL APPLICABILITY

The lead-free glass for semiconductor encapsulation of the present invention is suitable for a material for glass encapsulator used in encapsulating semiconductor devices such as silicone diodes, light-emitting diodes, thermistors.

Although the present invention has been described in detail and by reference to the specific embodiments, it is apparent to one skilled in the art that various changes or modifications can be made without departing from the spirit and scope of the present invention.

Incidentally, the present application is based on a Japanese Patent Application filed on Nov. 4, 2010 (Japanese Patent Application No. 2010-247306), the entire content of which is incorporated herein by reference. Further, all references cited herein are incorporated in its entirety.

1. A lead-free glass for semiconductor encapsulation, which comprises, as a glass composition, from 45 to 58% of SiO₂, from 0 to 6% of Al₂O₃, from 14.5 to 30% of B₂O₃, from 0 to 3% of MgO, from 0 to 3% of CaO, from 4.2 to 14.2% of ZnO, from 5 to 12% of Li₂O, from 0 to 15% of Na₂O, from 0 to 7% of K₂O, from 15 to 30% of Li₂O+Na₂O+K₂O, and from 0.1 to 8% of TiO₂, in terms of % by mol, wherein a ratio of ZnO to Li₂O is in the range from 0.84 to 2.

2. The lead-free glass for semiconductor encapsulation according to claim 1, which comprises, as a glass composition, from 49 to 53.6% of SiO₂, from 0.4 to 1.1% of Al₂O₃, from 15.5 to 18.2% of B₂O₃, from 0 to 0.5% of MgO, from 0 to 0.5% of CaO, from 7.4 to 9.9% of ZnO, from 5 to 10% of Li₂O, from 5 to 11% of Na₂O, from 0.1 to 2.3% of K₂O, from 19 to 25% of Li₂O+Na₂O+K₂O, and from 1.1 to 4% of TiO₂, wherein the ratio of ZnO to Li₂O is in the range from 0.85 to 1.5.

3. The lead-free glass for semiconductor encapsulation according to claim 1, which comprises less than 9% by mol of Li₂O.

4. The lead-free glass for semiconductor encapsulation according to claim 1, which comprises from 52.1 to 56.5% by mol of SiO₂+TiO₂.

5. The lead-free glass for semiconductor encapsulation according to claim 1, wherein a temperature corresponding to the viscosity of 10⁶ dPa·s is 650° C. or lower.

6. An encapsulator for semiconductor encapsulation made of the glass according to any one of claims 1 to 5.
